(19) United States
(12) Patent Application Publication
(10) Pub. No.: US 2016/0048904 A1
(43) Pub. Date: Feb. 18, 2016

(54) PET AVATAR PRIVATE LABELING AND PRODUCT FILING METHOD

(71) Applicants: Sumit Birla, Tampa, FL (US); Stephen Watters, Lutz, FL (US)

(72) Inventors: Sumit Birla, Tampa, FL (US); Stephen Watters, Lutz, FL (US)

(21) Appl. No.: 14/630,848

(22) Filed: Feb. 25, 2015

Related U.S. Application Data
(60) Provisional application No. 61/944,318, filed on Feb. 25, 2014.

(51) Int. Cl. G06Q 30/06

(52) U.S. Cl. CPC G06Q 30/0635

(57) ABSTRACT

The present invention is a method and system that enables consumers to easily and conveniently purchase breed specific products. The present invention creates a data store that relates animal breeds with specific products. A user is able to select a specific breed and/or breed variations resulting in a return of products suitable for the selected breed or breed variation. Additionally, the present invention provides images of the selected breed or breed variations with the products to aid the purchaser. After a product is purchased, a label is created and included on or included with the purchased products.

### BACKGROUND OF THE INVENTION

1. Field of the Invention

This invention relates, generally, to product tiling and labelling. More specifically, it relates to breed specific product filing and labelling.

2. Brief Description of the Prior Art

Dog owners have never been able to purchase products, such as nutritional supplements, dermatological products, skin & coat treatment, and treats, which are specific for the breed of dog they own. Specific breeds require specific products to improve the effectiveness of those products. Using a generic product on a breed that the product was not intended may render the product ineffective and possibly harmful. For example, a joint product formulated for a 120 lb. Great Dane is not suited for a small Pug.

Currently, dog owners buy a generic brand that does not refer to the specific dog breeds in which the product is intended. This is mostly due to physical stores not carrying breed specific consumables as stated above. One reason being, the stores would need over 16,000 stock keeping units required to cover all dog breeds, excluding thousands more for mutts.

Accordingly, what is needed is a method and system that enables consumers to easily and conveniently purchase breed specific products. However, in view of the art considered as a whole at the time the present invention was made, it was not obvious to those of ordinary skill in the field of this invention how the shortcomings of the prior art could be overcome.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of hat term in the reference does not apply.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF DESCRIPTION OF THE DRAWINGS

For a fuller understanding of the invention, reference should be made to the following detailed description, taken in connection with the accompanying drawings, in which:

FIG. 1 is a schematic diagram of a certain embodiment of the present invention,

FIG. 2 is a certain embodiment of a breed selection Webpage.

FIG. 3 is a certain embodiment of a Webpage of the present invention that provides the user with breed variants and breed specific products.

FIG. 4 is a certain embodiment of a Webpage of the present invention that provides a breakdown of the user's virtual shopping cart.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

The present invention is a system and method that enables the consumer to easily and conveniently purchase breed specific products, such as nutritional and dermatological products, that are specific for their breed of dog. In a certain embodiment, a user may be able to shop for multiple breeds if desired. The invention uses a number of factors in determining which products are applicable for each breed. A selection process is made by several factors, including but not limited to genetic conditions, hair, size, color, and disposition. Once the breed category of products are selected, a labeling system furthers allow the consumer to choose which dog most resembles their own dog and ship the consumable products with the label that identifies the breed, color, hair and size. For example, if a consumer owns a black pug weighing 15 lbs., the product recommended for a 15 lb. black pug will have a photo with or on the product that resembles the black pug to help the consumer identify the best product for their breed.

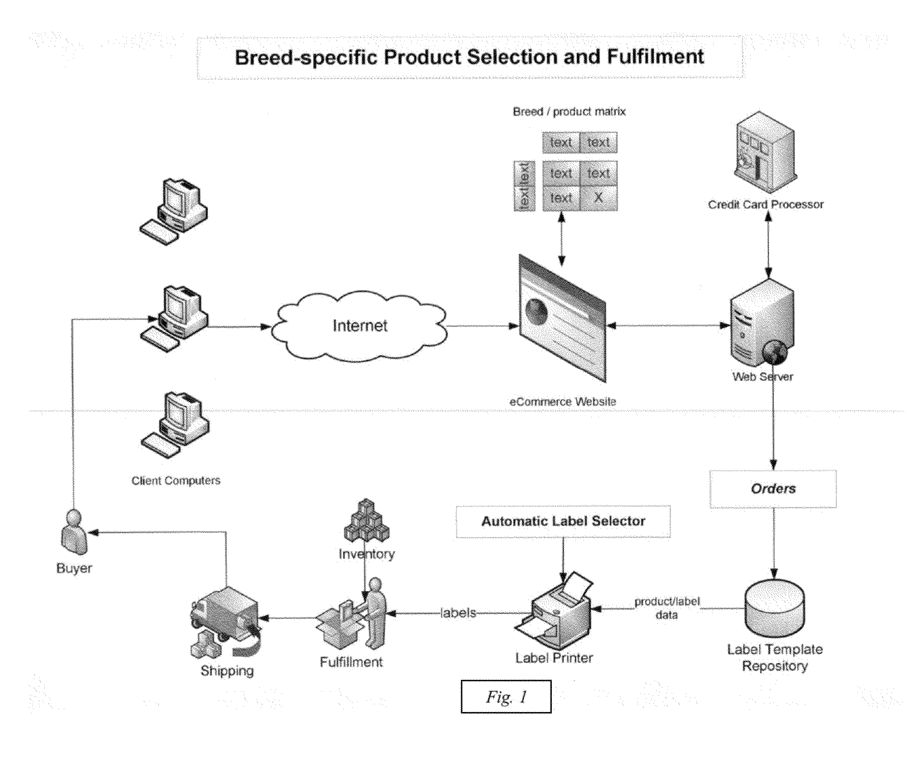

As shown in FIG. 1, the present invention provides a system and method for creating and ordering breed-specific merchandise over a computer network, more specifically over the World Wide Web (WWW). The system is preferably a server based program, but may also be a client side program that sends a transmission to the server upon completion of the order. The initial set up of the system involves loading all available products into a database or breed/product matrix, Each product in turn has assigned attributes, including but not limited to the following:
1. Suitable for size of dog: Small, Medium, Large, Giant
2. Suitable for color type: White?
3. Suitable for hypoallergenic? Y/N
3. Good for joints? Y/N
5. Good for digestive system? Y/N

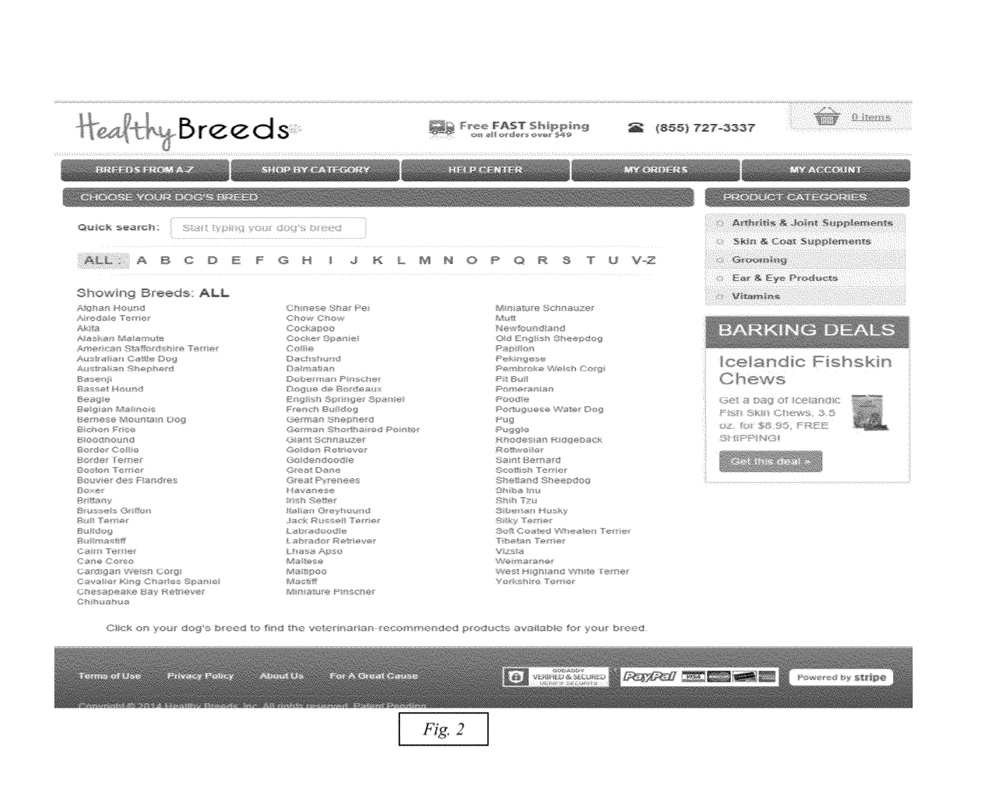

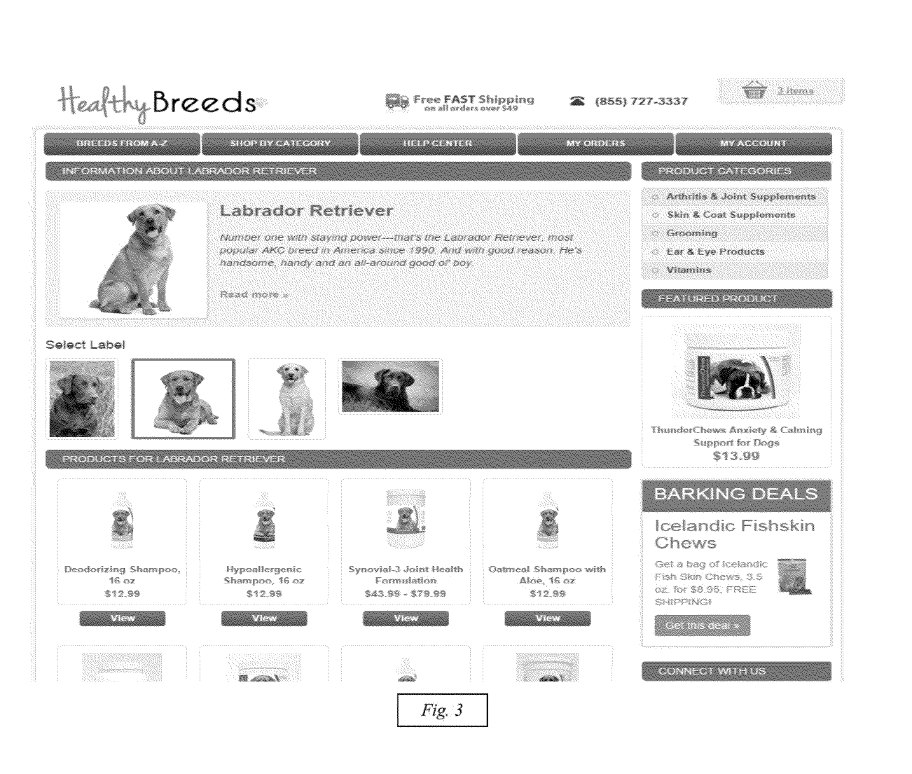

A customer visiting the WWW site is presented with a list of breeds to select as shown in FIG. 2. In a certain embodiment, the user can select more than one breed. Once a breed is selected, the system presents the customer with a list of products suitable for the breed as shown in FIG. 3. For example, whitening shampoo will only be shown for dogs with white coat. The products to be presented are based on a decision engine utilizing data previously loaded and the breed's genetic conditions, such as, but not limited to hair, size, color, and disposition.

Additionally, the products displayed are customized with the exemplary image assigned to the selected breed and breed variants (See FIG. 3). In cases where a breed can exist with variations in color, the customer is able to select a particular variation—(e.g. Labrador retriever—white, golden, and chocolate variations). If the user selects a particular variation, the present invention accesses the breed/product matrix and retrieves the products related to the breed variant. In a certain embodiment, there may exist a separate breed variant/product matrix to store the products related to specific breed variant, which would only be accessed if a user selected a breed variant. In yet another embodiment, the breed variations may be presented to the user when asked to select a breed.

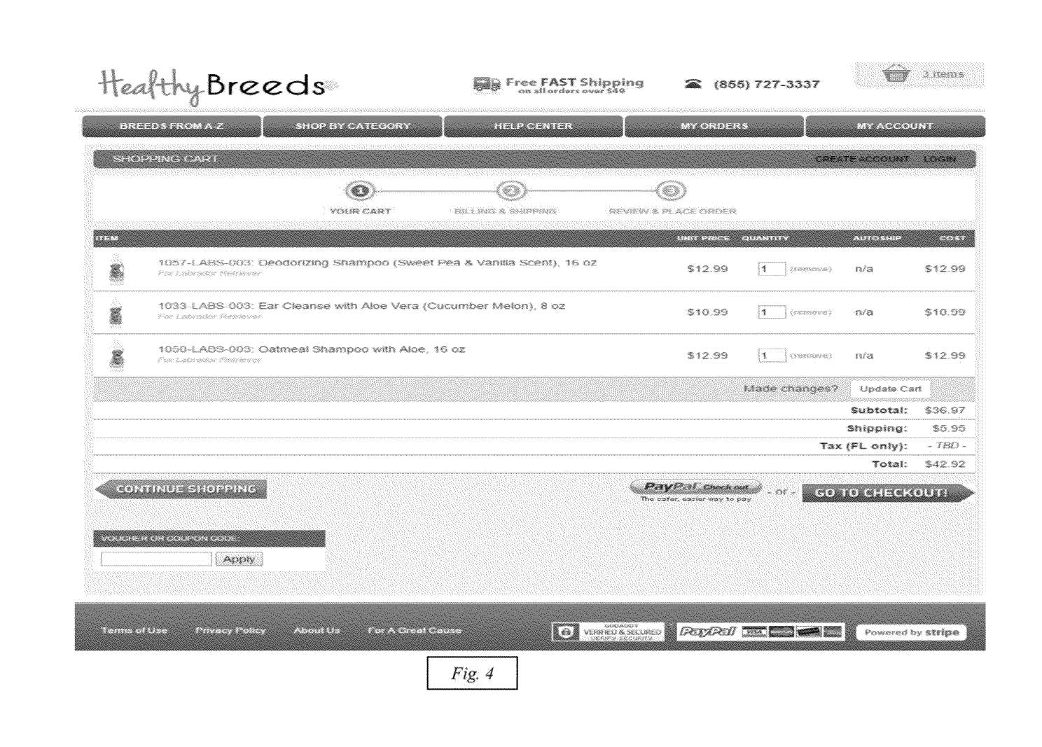

After viewing the displayed products, the customer can add products to his/her shopping cart and checkout (as shown in FIG. 4) using a standard eCommerce workflow as is known by a person having ordinary skill in the art. Once the order has been placed, it is sent into a queue in the Healthy Breeds fulfillment system (See FIG. 1). As further shown in FIG. 1, a computer-controlled apparatus automatically prints instructions to retrieve the items from inventory. Additionally, it prints the appropriate label for each item. The label is selected based on the product, size, and selected breed. A database of labels (Label Template Repository) containing graphics decides the proper resolution based on dimensions of the item and sends it to the printer. The label is then affixed to the item and the item is packages and shipped. The affixing and shipping may be performed by a person or may be completely automated.

In a certain embodiment, the present invention assigns exemplary images for each dog breed and breed variant, which may be stored by any means known to a person having ordinary skill in the art. The present invention preferably automatically assigns the exemplary images, but the images may be assigned manually. Additionally, a certain embodiment may allow a user to upload an image of his/her dog to be used as a label for the products purchased for that specific dog.

In a certain embodiment, the present invention allows a user to create an account and store the user's selected breed or breeds along with any pictures of the user's animal(s). In such an embodiment, the present invention would bypass the breed selection process and display products related to the user's stored breed(s).

In a certain embodiment, the present invention may be utilized to identify products useful for animals with common genetic conditions that are not necessarily specific to certain breeds. For example, the present invention may provide the option of searching for products related to certain skin disorders such as mange. In such an embodiment, there may also exist a data store cross-referencing the products with certain breeds. For example, if the user's dog has mange, but the dog is a breed known to have sensitive skin (such as a Blue Pit Bull) the present invention may provide the user with a product designed for Blue Pit Bulls with mange.

In a certain embodiment, the present invention may be utilized for any species of animals and not just limited to dogs.

### Glossary of Claim Terms

Label Template Repository: is a data store comprising of labels related to specific animal breeds.

Breed/Product Matrix: is a matrix relating animal breeds and breed specific products.

Computer: is any electronic device capable of accessing the Web.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A non-transitory, tangible computer-readable media having computer-executable instructions for performing a method by running a software program on a computer, the computer operating under an operating system, the method including issuing instructions from the software program to create and receive orders of breed-specific merchandise over a computer network, the instructions comprising:
establishing a data connection between a user's computer and a remote web server;
receiving a user selected breed from a list of breeds;
accessing a breed/product matrix and selecting the products related to the selected breed, the breed/product matrix is a predetermined matrix having a plurality of breeds with a product related to each breed;
displaying to the user the products related to the selected breed;
receiving a list of products the user has selected;
receiving shipping and purchase information from a user such that an electronic purchase can be completed;
completing a purchase;
communicating with a label template repository, the label template repository containing a plurality of labels related to breeds of animals; and
automatically selecting the label related to the user selected breed and producing the selected label to be affixed to the corresponding product.

2. One or more non-transitory tangible computer-usable media as in claim 1, further comprising:
the step of determining whether there are any breed variations of the selected breed and displaying to the user any variations in the selected breed along with any products related to the selected breed variation.

3. One or more non-transitory tangible computer-usable media as in claim 2, further comprising:
the breed/product matrix including breed variations with products related to the breed variations.

4. One or more non-transitory tangible computer-usable media as in claim 2, further comprising:
a breed variation/product matrix that relates breed variations with products specific to the breed variations.

5. One or more non-transitory tangible computer-usable media as in claim 2, further comprising:
the label selected identifies the breed variation, color, hair, and size and includes an exemplary image of the user selected breed variation.

6. One or more non-transitory tangible computer-usable media as in claim 1, further comprising:
the breed/product matrix being automatically created by comparing the features and characteristics of a plurality of breeds with information specific to the products.

7. One or more non-transitory tangible computer-usable media as in claim 6, further comprising:
the features and characteristics of a plurality of breeds include genetic conditions, hair, size, color, and disposition.

8. One or more non-transitory tangible computer-usable media as in claim 6, further comprising:
the information specific to the products includes an intended size of the animal for which the product was designed, an intended hair color of the animal for which the product was designed, whether the product is good for joints, and whether the product is good for a digestive system.

9. One or more non-transitory tangible computer-usable media as in claim 1, further comprising:
the label selected identifies the breed, color, hair, and size and includes an exemplary image of the user selected breed.

10. One or more non-transitory tangible computer-usable media as in claim 9, further comprising:
the exemplary image being uploaded by the user.

11. One or more non-transitory tangible computer-usable media as in claim 1, further comprising:
the products related to the selected breed and displayed to the user are accompanied by an exemplary image of the breed.

12. A computer-based system for creating and receiving orders of breed-specific merchandise over a computer network, comprising:
a computer operable to execute the instructions comprising:
establishing a data connection between a user's computer and a remote web server;
receiving a user selected breed from a list of breeds;
accessing a breed/product matrix and selecting the products related to the selected breed, the breed/product matrix is a predetermined matrix having a plurality of breeds with a product related to each breed;
displaying to the user the products related to the selected breed;
receiving a list of products the user has selected;
receiving shipping and purchase information from a user such that an electronic purchase can be completed;
completing a purchase;
communicating with a label template repository, the label template repository containing a plurality of labels related to breeds of animals; and
automatically selecting the label related to the user selected breed and producing the selected label to be affixed to the corresponding product.

13. The computer-based system as in claim 12, further comprising:
the step of determining whether there are any breed variations of the selected breed and displaying to the user any variations in the selected breed along with any products related to the selected breed variation.

14. The computer-based system as in claim 13, further comprising:
the breed/product matrix including breed variations with products related to the breed variations.

15. The computer-based system as in claim 13, further comprising:
a breed variation/product matrix that relates breed variations with products specific to the breed variations.

16. The computer-based system as in claim 12, further comprising:
the breed/product matrix being automatically created by comparing the features and characteristics of a plurality of breeds with information specific to the products.

17. The computer-based system as in claim 16, further comprising:
the features and characteristics of a plurality of breeds include genetic conditions, hair, size, color, and disposition.

18. The computer-based system as in claim 16, further comprising:
the information specific to the products includes an intended size of the animal for which the product was designed, an intended hair color of the animal for which the product was designed, whether the product is good for joints, and whether the product is good for a digestive system.

19. The computer-based system as in claim 12, further comprising:
the label selected identifies the breed, color, hair, and size and includes an exemplary image of the user selected breed.

20. The computer-based system as in claim 12, further comprising:
the products related to the selected breed and displayed to the user are accompanied by an exemplary image of the breed.
